(19) United States
(12) Patent Application Publication
(10) Pub. No.: US 2005/0110779 A1
(43) Pub. Date: May 26, 2005

(54) Pen-like mouse device

(76) Inventors: Hsun-Li Huang, Hsinchu City (TW); Chun-Hsiung Yin, Tainan (TW); Chih-Wei Wu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/992,039

(22) Filed: Nov. 18, 2004

(30) Foreign Application Priority Data
Nov. 21, 2003 (TW) 092132843

(51) Int. Cl. G09G 5/00

(52) U.S. Cl. 345/179

(57) ABSTRACT

A pen-like mouse device includes a mouse body, a sensor, a scroll wheel, and a first button. The mouse body has a front end, a rear end, and a base. A scroll wheel is disposed on the base. The sensor is disposed on the front end of the mouse body. The first button is disposed on the opposite side of the base of the pen-like mouse device. While a user operates the pen-like mouse device, the sensor of the pen-like mouse device contacts a plane surface and the first button and the scroll wheel are controlled by different fingers of the user.

This application claims the benefit of Taiwan application Serial No. 92132843, filed Nov. 21, 2003, the subject matter of which is incorporated herein by reference.

### BACKGROUND OF THE INVENTION

1. Field of the Invention

The invention relates in general to a mouse, and more particularly to a pen-like mouse.

2. Description of the Related Art

Referring to FIG. 1A to 1C. FIG. 1A is a top plane view of a traditional vertical optical mouse, FIG. 1B is a side view of the traditional vertical optical mouse, and FIG. 1C is a perspective view picture of the traditional vertical optical mouse. In FIG. 1A and FIG. 1B, the traditional vertical optical mouse 100 has a mouse body 140, a base 110, a first button 120, and a second button 130. The base 110 is in contact with the plane 10, and the traditional vertical optical mouse moves along the plane 10. The first button 120 and the second button 130 are arranged on a straight vertical line of the mouse body 140.

Because of the sites that the first button and the second button are disposed, one has to use the same finger to press two different buttons as shown in FIG. 1C. Therefore, mis-pressing the buttons occurs frequently. Besides, pressing the buttons by using one single finger could hurt the muscle of the finger easily after long-term use. And the vertical arrangement of the buttons causes unbalance and instability of the mouse.

A further disadvantage of the traditional vertical optical mouse is that it doesn't have the scroll wheel so that using the traditional vertical optical mouse to browse the web site, access documents, and images is not convenient. Therefore, a vertical mouse with buttons easy to be pressed and an additional scroll wheel could be more convenient and humanistic to users.

### SUMMARY OF THE INVENTION

It is therefore an object of the invention to provide a pen-like mouse, wherein the buttons are disposed on the different sites from the traditional vertical optical mouse and holding the pen-like mouse differs from the traditional vertical optical mouse. Moreover, the pen-like mouse has a scroll wheel that isn't disposed on the traditional vertical optical mouse. Therefore, the special invention is a pen-like mouse with a scroll wheel and easy to press the buttons.

The invention achieves the above-identified object by providing a pen-like mouse, includes a mouse body, a sensor, a scroll wheel, and a first button. The mouse body has a front end, a rear end, a base, and a sensing surface, wherein the front end is opposite to the rear end and the sensing surface is on the front end of the pen-like mouse. The scroll wheel is disposed on the base, and the sensor is disposed on the sensing surface. The first button is disposed on the opposite side to the base of the pen-like mouse. When using pen-like mouse, the sensing surface moves along the plane, the first button and the scroll wheel are controlled by different fingers, and the rear end leans between the thumb and the index finger

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is the top plane view of the traditional-perpendicular-optical mouse.

FIG. 1B is the side view of the traditional-perpendicular-optical mouse.

FIG. 1C is a perspective view picture of the traditional-perpendicular-optical mouse.

FIG. 2A is a top plane view of the pen-like mouse.

FIG. 2B is a side view of the pen-like mouse.

FIG. 2C is a bottom plane view of the pen-like mouse.

FIG. 2D is front elevation view of the pen-like mouse, viewing from the sensor.

FIG. 3A and FIG. 3B are the perspective view pictures of operating the pen-like mouse.

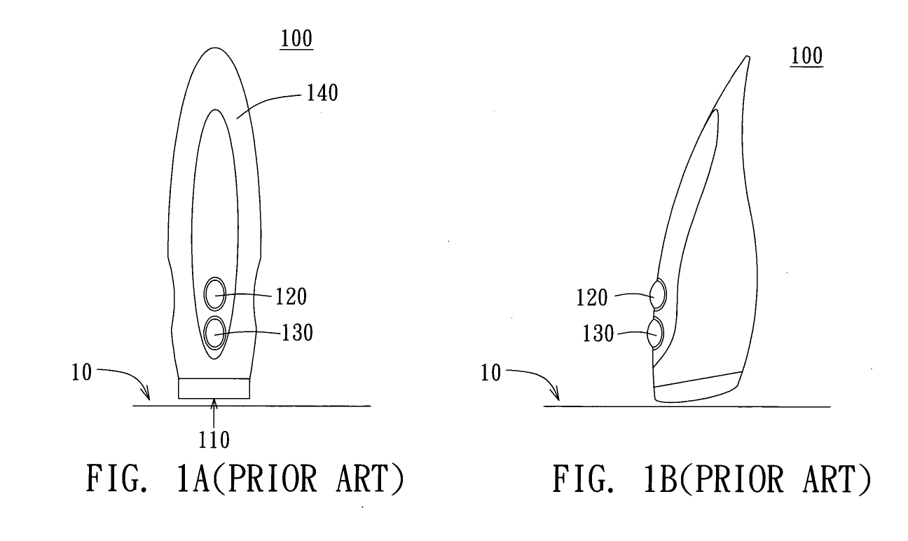

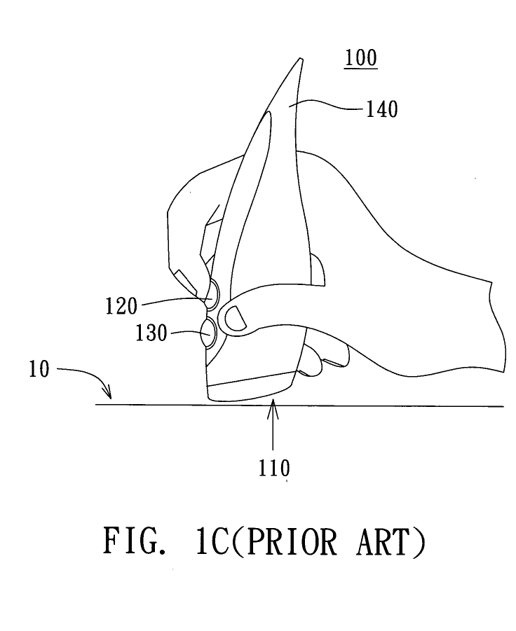

### DETAILED-DESCRIPTION OF THE INVENTION

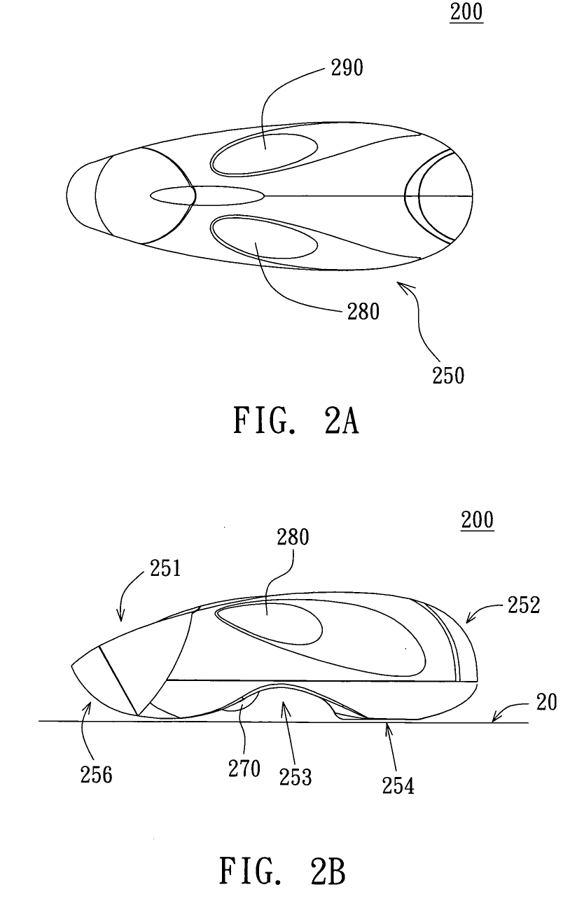

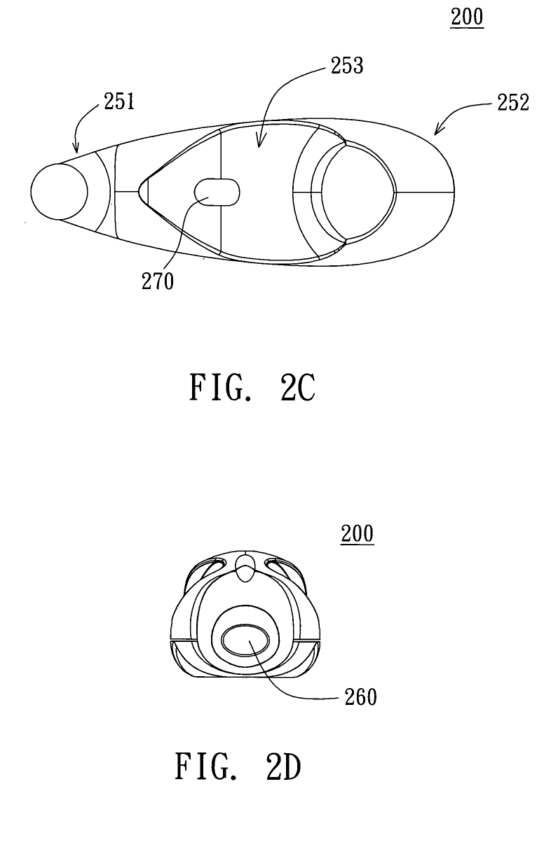

Please refer to FIG. 2A to 2D. FIG. 2A is a top plane view of the pen-like mouse, FIG. 2B is a side view of the pen-like mouse, FIG. 2C is a bottom plane view of the pen-like mouse, and FIG. 2D is front elevation view of the pen-like mouse, viewing from the sensor. The pen-like mouse 200 includes at least a mouse body 250, a sensor 260, a scroll wheel 270, and a first button 280. The pen-like mouse can further include a second button 290. The mouse body 250 has the front end 251, the rear end 252 and the base254. The front end 251 of the mouse body 250 is opposite to the rear end of the mouse body. The scroll wheel 270 is disposed on the base 254 of the mouse body 250. The sensor 260 is disposed on the front end 251 of the mouse body 250. The first button 280 is on the opposite side to the base 254 of the pen-like mouse 200. If the second button 290 is included, the second button 290 is disposed on the different side from the sides on which the first button 280 and the base 254 are disposed.

When a user operates the pen-like mouse 200, the front end 251 of the pen-like mouse 200 is in contact with a plane 20. Then, the pen-like mouse can move along the plane 20. The first button 280 and the second button 290 are controlled by different fingers of the user, such as thumb and index finger selectively. The button arrangement of the pen-like mouse according to the invention has the advantages of less chance of button mis-pressing as well as preventing muscle hurt after long-term use. Besides, the user can selectively use either the middle, ring, or little finger to operate the scroll wheel 270 on the base 254. The disposition of the scroll wheel 270 according to the invention provides the user an easy way to browse web page, access document, or images.

Referring to FIG. 2B, the front end 251 of the pen-like mouse 200 has a sensing surface 256, and the sensor 260 is disposed on the sensing surface 256. Besides, the base 254 of the pen-like mouse 200 has a concave part 253, and the scroll wheel 270 is disposed in the concave part 253. The sensing surface 256 makes the pen-like mouse 200 to move along the plane 20. The first button 280, the second button 290, the scroll wheel 270 in the concave part 253, and the sensor 260 on the sensing surface 256 can be used to control the cursor of the screen. The disposition of the sensing surface 256 in the front end 251 and design of the concave part 253 in the base 254 according to the invention help the users to hold the pen-like mouse with more comfort. The shape and the size of the pen-like mouse can be designed to fit the user's hand. Thus, the user can hold the pen-like mouse more steadily. In order to describe the invention more clearly, the following is an example of a pen-like mouse with a special design of shape and size which properly fits the hand of users.

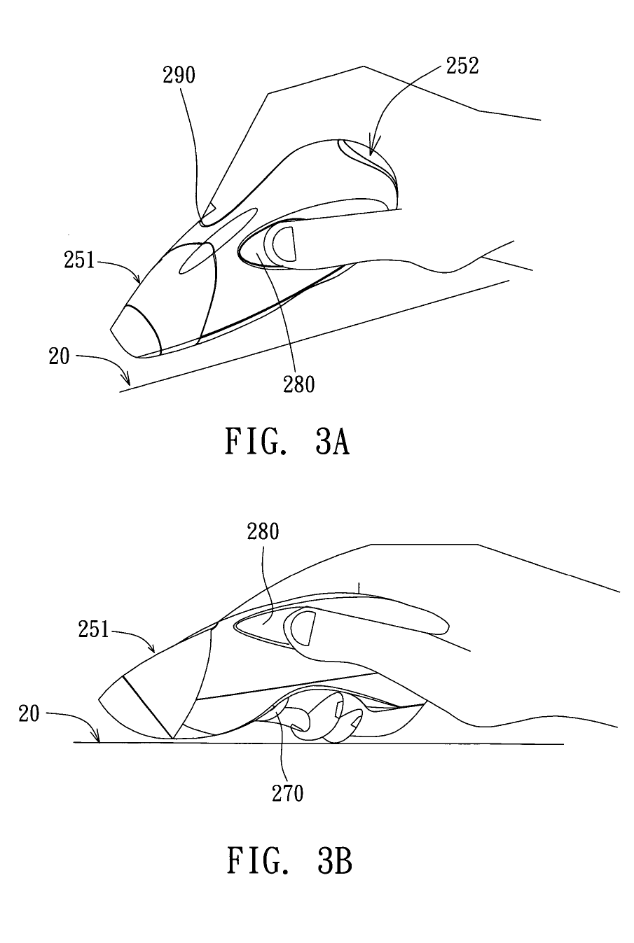

Referring to FIGS. 3A and 3B simultaneously, FIGS. 3A and 3B are the perspective views when a user operates the pen-like mouse. The size and shape of the pen-like mouse in FIG. 3Aand FIG. 3B properly fit the space between the thumb and the index finger. The radian of the curved surface on the rear end 252 is similar to the radian of the curve between the thumb and the index finger.

In operation, the sensing surface 256 moves along the plane 20, the rear end 252 leans between the thumb and the index finger, the first button and the second button are controlled by different fingers, and the scroll wheel 270 can be operated selectively by middle finger, ring finger or little finger. By the above-mentioned method, the thumb and index finger can hold the mouse more steadily. Therefore, the user can press the buttons without moving the pen-like mouse. Moreover, no matter the user is right-handed or left-handed, he can use the pen-like mouse easily.

The method of disposing the button and scroll wheel as above can solve the incommodity of the application of the buttons of the traditional-optical mouse. The first button 280 is opposite to the base 254. When the second button 290 is included, the second button is on the opposite side of the first button, and the second button 290 is also opposite to the base 254. Mis-pressing the buttons is rarely happened according to this design, when pressing the first button by thumb and pressing the second button by the index finger. Besides, the pen-like mouse 200 has the scroll wheel 270. One can page up and down the web page by rolling the scroll wheel 270. Therefore, it is easier and more convenient to browse the web site, access documents, and images.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A pen-like mouse device, comprising:
a mouse body, having a front end, a rear end, and a base, wherein the front end is opposite to the rear end;
a sensor on the front end;
a scroll wheel on the base; and
at least a first button, on an opposite side to the base of the pen-like mouse;
wherein the first button and the scroll wheel are controlled by different fingers of a user.

2. The pen-like mouse device as claimed in claim 1, wherein the front end further comprises a sensing surface with the sensor disposed thereon and the sensing surface moves along a plane.

3. The pen-like mouse device as claimed in claim 1, wherein the rear end of the pen-like mouse device leans between thumb and index finger of the user.

4. The pen-like mouse device as claimed in claim 1, wherein the user operates the scroll wheel by middle finger, ring finger or little finger selectively.

5. The pen-like mouse device as claimed in claim 1, wherein the base of the pen-like mouse device further comprises a concave part with the scroll wheel disposed therein.

6. The pen-like mouse device as claimed in claim 1, wherein the pen-like mouse device is a wireless optical mouse.

7. A pen-like mouse device, comprising:
a mouse body, having a front end, a rear end, a base, and a sensing surface, wherein the front end is opposite to the rear end, and the sensing surface is on the front end of the pen-like mouse;
a sensor on the sensing surface;
a scroll wheel on the base; and
a first button, on an opposite side to the base of the pen-like mouse device;
wherein the sensing surface moves along the plane, the first button and the scroll wheel are controlled by different fingers of an user, and the rear end leans between thumb and index finger of the user.

8. The pen-like mouse device as claimed in claim 7, wherein the user operates the scroll wheel by middle finger, ring finger or little finger selectively.

9. The pen-like mouse device as claimed in claim 7, wherein the base of the pen-like mouse device further comprises a concave part with the scroll wheel disposed therein.

10. The pen-like mouse device as claimed in claim 7, wherein the pen-like mouse is a wireless optical mouse.
